(19) United States
(12) Patent Application Publication
(10) Pub. No.: US 2008/0094170 A1
(43) Pub. Date: Apr. 24, 2008

(54) Method for Establishing an Access for a User to a System

(75) Inventors: Thomas Portele, Bonn (DE); Vasanth Philomin, Stolberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,533

(22) PCT Filed: Jul. 4, 2005
(86) PCT No.: PCT/IB05/52219

§ 371 Date: Jan. 2, 2007

(30) Foreign Application Priority Data
Jul. 5, 2004 (EP) 04103169.1

(51) Int. Cl. G06F 7/04; G06K 9/00; G10L 17/00

(52) U.S. Cl. 340/5.2; 382/118; 704/246; 704/E17.001

(57) ABSTRACT

This invention relates to a method and a system for introducing and converting a new user (103) to a known user of a system (109), where a known user is a user whose characteristics are pre-stored in said system (109) and who, based on a match between detected characteristics and said pre-stored characteristics, is identified as a known user. This is done by initializing the introduction of the new user when receiving an introduction action by a known user (101), detecting characteristics of the new user and converting the new user (103) to a known user by adding the detected characteristics to the pre-stored characteristics in the system (109).

The present invention relates to a method and a device for introducing and converting a new user to a known user of a system where the introduction is done by a user that is known to the system.

Current research and product trends are geared towards personalized user interfaces that support individual customization and are aware of the preferences of their users. Well known examples are the personalized desktop and other settings available to a user after logging into a modem computer system. Ideally the interface is able to recognize a user without any login procedures by biometrical assessment. Examples of such login procedures are described in WO2002079954, EP1191517 and WO2002086865. In WO2002079954 a system is disclosed where if a user is recognized by face recognition, a set of interconnected devices configures itself according to the user's preferences. EP1191517 discloses a spoken dialogue system using a personalization by a dynamic user model, and WO2002086865 discloses a method where a user is recognized by speaker recognition and speaker-specific information. An important convenience issue is the user enrolment. If a user is to be recognized by biometrical features like voice or face, the specific parameters must be obtained by samples of spoken words and/or images. Furthermore, the name of the user must be known to the system. An example of systems that use speech input and output use recognition is disclosed in EP1085499 and WO200124161.

The common problem with the above systems is how tedious it is to introduce a new user to the systems. Due to this the systems loose their human-like ability, which is the main objective when developing such systems. Further, the lack of human-like ability can easily jeopardize the security when introducing a new user to the systems.

It is the object of the present invention to solve the above mentioned problems.

According to one aspect the present invention relates to a method for introducing and converting a new user to a known user of a system, where a known user is a user whose characteristics are pre-stored in said system and who, based on a match between detected characteristics and said pre-stored characteristics, is identified as a known user, the method comprises the steps of:

initializing said introducing of said new user when receiving an introduction action by a known user,

based on said introduction action detecting characteristics of said new user, and

converting said new user to a known user by adding at least one of said detected characteristics to said pre-stored characteristics in said system.

Therefore, human-human introduction conventions can be transferred to enrolments of new users for a user interactive system, assuming that one user is already known to the system, and explicit enrolment procedures are avoided. Further, the necessity of the known user to perform the introduction is an additional security feature.

In an embodiment the introduction action comprises pointing towards the new user. This facilitates the finding task for the device of the new user during the introduction action. Also, when more than two people are present, the device is aware of, through said pointing, which one of the persons present is to be introduced.

In an embodiment the introduction action comprises oral information relating to said new user. This makes the introduction action even more human like, since a normal introduction between people comprises introducing themselves orally. This oral introduction action could comprise, as an example, a code representing that the known user wants to introduce a new user. As an example, this code could comprise: “add new user”, which could result in that the device goes into “add new user mode”, which initiates the steps mentioned above.

In an embodiment detecting characteristics of said new user comprises a face detection of the new user. Thereby one or more face characteristics are obtained in a convenient way and used for identifying the new user. This can comprise a certain characteristics from the user's eyes or the shape of the user's head or the users face.

In an embodiment detecting characteristics of said new user comprises detecting the acoustics from the new user. The user's voice can therefore be detected and distinguished from other voices or sounds. This could, as an example, be done by using a speaker identification module. This increases the security level of the system further. In another embodiment the characteristics of said new user comprise both said face detection characteristics and the acoustics from the new user. Thereby, through this combination, the interaction between the user and the system is more human-like.

In a further aspect the present invention relates to a computer readable medium having stored therein instructions for causing a processing unit to execute said method.

In another aspect the present invention relates to a device for introducing and converting a new user to a known user of a system, where a known user is a user whose characteristics are pre-stored in said system and who, based on a match between detected characteristics and said pre-stored characteristics, is identified as a known user, comprising:

means for initializing said introducing of said new user when receiving an introduction action by a known user,

a detector for detecting characteristics of said new user, and

a processor converting said new user to a known user by adding at least one of said detected characteristics to said pre-stored characteristics in said system.

Thereby, a device is provided where explicit enrolment procedures are avoided, and which supports human-human conventions, and which allows an easy and human like way to introduce and convert a new user to a known user of a system by biometrical features. Simultaneously, since the introduction is performed by a known user that has been positively identified by the device, a high security level is provided.

In an embodiment said detector comprises a digital camera. Thereby one or more face characteristics for the new user may be determined and be added to said pre-stored characteristics.

In an embodiment said detector comprises an acoustic sensor. Thereby a speaker acoustic identification model may be generated for the new user and be used as acoustic characteristics for the new user and be added to said pre-stored characteristics.

In the following the present invention, and in particular preferred embodiments thereof, will be described in more details in connection with accompanying drawing in which

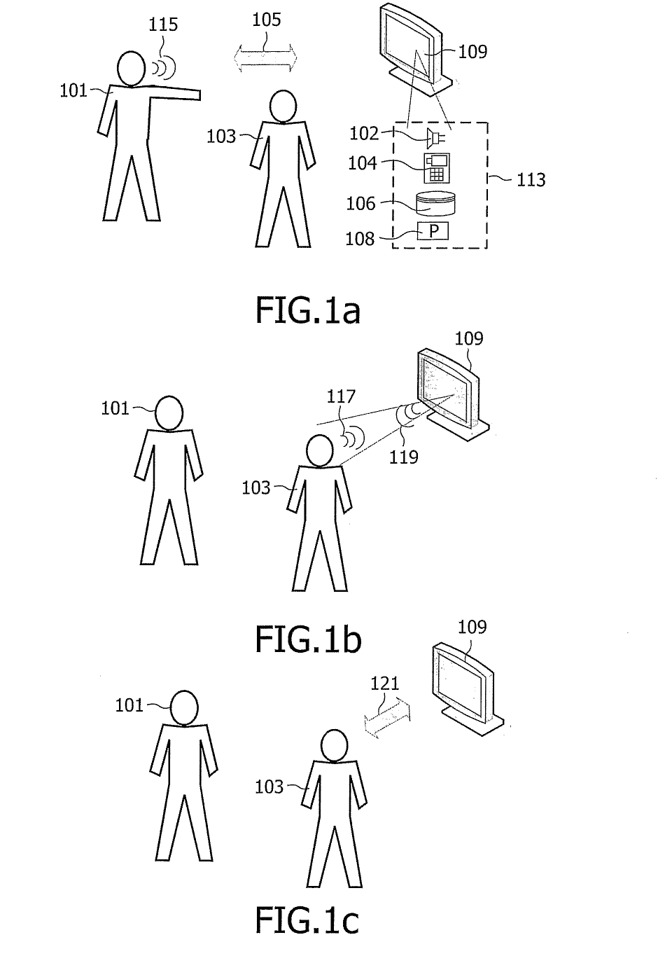

FIG. 1 shows a device for introducing and converting a new user to a known user of a system,

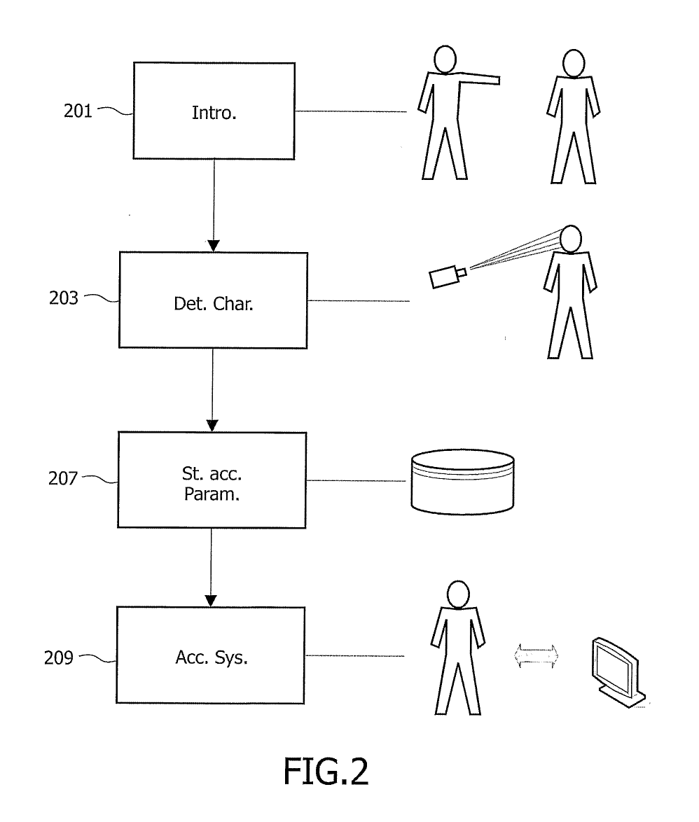

FIG. 2 shows a flowchart of an embodiment of a method for introducing and converting a new user to a known user of a system, and

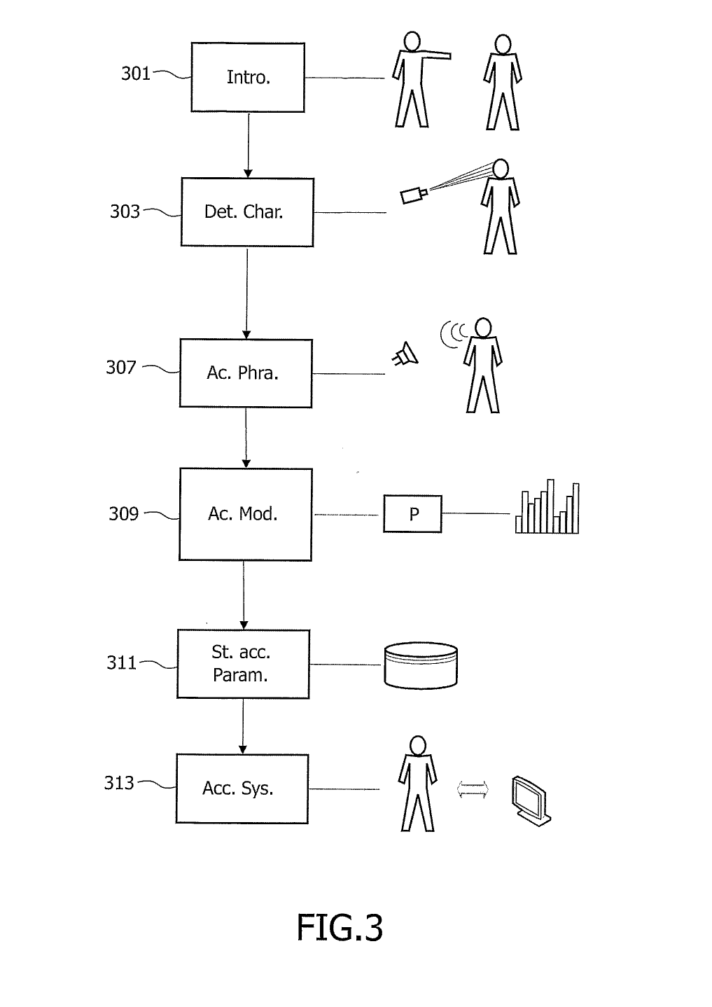

FIG. 3 shows a flowchart of another embodiment of a method for introducing and converting a new user to a known user of a system.

FIG. 1 shows a device 113 for introducing and converting a new user 103 to a known user of a system 109, where a known user is a user whose characteristics are pre-stored in said system 109 and who, based on a match between detected characteristics and said pre-stored characteristics, is identified as a known user. In this example the system 109 is a computer, and the device 113 is integrated into the computer 109. The device 113 can also be situated externally from the system 109. The system 109 can in general be any kind of electrical system. The device 113 comprises a detector 102, 104 for detecting characteristics of said new user 103 and a processor 108 converting said new user 103 to a known user by adding at least one of the detected characteristics to said pre-stored characteristics in said system 109. In this embodiment the detector 102, 104 comprises a digital camera 104 and an acoustic sensor 102 for detecting one or more face characteristics and the voice of the new user 103.

As illustrated in FIG. 1a, the new user 103 is introduced to the system 109 by a user 101 that is known to the system 109. First, the known user 101, which is connected to the system 105, introduces the new user 103 to the system 109 by e.g. pointing towards the new user 103. The introduction may further comprise an oral introduction, e.g. speaking 115 the name of the new user 103. The camera 104 follows the pointing and focuses on the new user 103 by e.g. face detection and obtains images. The processor 108 determines face characteristics based on known phase recognition methods and adds the resulting characteristics in a storage means 106 having pre-stored characteristics of other users. These characteristics may comprise a certain characteristic from the user's eyes or a pattern in the images. As illustrated in FIG. 1b, the device 109 asks 119 the new user 103 to repeat some phrases. Based on the answer 117 from the new user 103 the processor generates an acoustic identification model for the new user 103 or acoustic characteristics, which are stored in said storage means 106.

In FIG. 1c the user 103 has been converted to a known user, which is known to the system 109 and therefore has an access to interact 121 with the system 109.

In one embodiment a photographic image is used to introduce and convert a new user 103 to a known user of a system 109. In this embodiment the device 113 utilizes only the images to provide an access to a new user so that the characteristics comprise only face characteristics. Therefore, the new user does not necessarily have to be present when introducing him to the system 109.

As an example, a known user is recognized by the device called “Dimi”.

A new user may be introduced by a dialogue like:
1. Known user: “Dimi, meet my friend Harold!”
2. Device (While using face detection and face recognition to find an unknown face, the device assumes that this is the new user and takes pictures to include them in the image database.): “Hi Harold, nice to meet you!”
3. Harold: “Hello Dimi” (device stores the utterance or the acoustics for adoption of speech recognition and speaker identification parameters).

FIG. 2 shows a flowchart of an embodiment of a method for introducing and converting a new user to a known user of a system. Initially the new user is introduced to the system (Intro.) 201 by a known user, which has been positively identified by the system (the device). The introduction may be done e.g. by pointing towards the new user by another user that is known to the system. Also, the known user could use a photo of the new user. One or more characteristics of the new user (or the photo) are detected (Det. Char.) 203 by a scanner, a digital camera or a similar means. These characteristics can e.g. comprise characteristics in the eyes of the new user, distances between different parts of the face based on the light intensity in the image matrix detected by the camera. Subsequently the detected characteristics are stored (St. acc. Param.) 207 in a storage means comprising a pre-stored characteristics. Thereby, when the new user wants to access the system, the device detects one or several characteristics and compares them to the pre-stored characteristics. Therefore, when a match is found, the user has accessed the system (Acc. Sys.) 209.

FIG. 3 shows a flowchart of another embodiment of a method for introducing and converting a new user to a known user of a system. As described previously in FIG. 2, the new user is introduced to the system (Intro.) 301, and one or more characteristics of the new user are detected (Det. Char.) 303. In addition to the embodiment described in FIG. 2, the device further detects the voice of the new user, e.g. by asking the user to repeat some phrases (Ac. Phra.) 307, and based thereon generates an acoustic identification model (Ac. Mod.) 309 or acoustic characteristics for the new user. These characteristics are then stored (St. acc. Param.) 311 in a storage means comprising a pre-stored characteristic. Therefore, when said new user wants to access the system, a processor would check whether there is a match between one or more detected characteristics and the pre-stored characteristics. If there is a match, the access to the system would be permitted (Acc. Sys.) 313.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for introducing and converting a new user (103) to a known user of a system (109), where a known user is a user whose characteristics are pre-stored in said system (109) and who, based on a match between detected characteristics and said pre-stored characteristics, is identified as a known user, the method comprises the steps of:
initializing said introducing of said new user when receiving an introduction action by a known user (101),
based on said introduction action detecting characteristics of said new user, and
converting said new user (103) to a known user by adding at least one of said detected characteristics to said pre-stored characteristics in said system (109).

2. A method according to claim 1, wherein said introduction action comprises pointing towards the new user (103).

3. A method according to claim 1, wherein said introduction action comprises oral information relating to said new user (103).

4. A method according to claim 1, wherein detecting characteristics of said new user (103) comprises a face detection of the new user (103).

5. A method according to claim 1, wherein detecting characteristics of said new user (103) comprises detecting the acoustics from the new user (103).

6. A computer readable medium having stored therein instructions for causing a processing unit to execute method of claim 1.

7. A device (113) for introducing and converting a new user (103) to a known user of a system (109), where a known user is a user whose characteristics are pre-stored in said system (109) and who, based on a match between detected characteristics and said pre-stored characteristics, is identified as a known user, comprising:
means for initializing said introducing of said new user (103) when receiving an introduction action by a known user (101),
a detector (102, 104) for detecting characteristics of said new user, and
a processor (108) converting said new user (103) to a known user by adding at least one of said detected characteristics to said pre-stored characteristics in said system (109).

8. A device according to claim 7, wherein said detector comprises a digital camera (104).

9. A device according to claim 7, wherein said detector comprises an acoustic detector (102).
